(19) United States
(12) Patent Application Publication
(10) Pub. No.: US 2008/0276942 A1
(43) Pub. Date: Nov. 13, 2008

(54) Re-Breather Apparatus With Vaned Filtering Canister

(76) Inventor: Kevin Gurr, Dorset (GB)

Correspondence Address: Powley & Gibson, P.C., 304 Hudson Street, 2nd Floor, New York, NY, 10013, US

(21) Appl. No.: 11/885,649

(22) PCT Filed: Mar. 3, 2006
(86) PCT No.: PCT/IB06/02695

§ 371 Date: Sep. 4, 2007

Related U.S. Application Data
(60) Provisional application No. 60/658,606, filed on Mar. 4, 2005.

(51) Int. Cl. A62B 7/10

(52) U.S. Cl. 128/205.28

(57) ABSTRACT

A breathing apparatus having a source of oxygen and a mouthpiece, which includes an inlet connected through a first one-way valve to receive inhaled gas, and an outlet having a second one-way valve to expel exhaled gas from a user. A scrubber canister is coupled to the mouthpiece and receives the output of the mouthpiece through the second one-way valve. The scrubber canister removes at least a portion of carbon dioxide from the exhaled gas from the user, and outputs carbon dioxide depleted gas. The scrubber canister has an inner canister and an outer canister and a plurality of vanes disposed between the inner canister and the outer canister. The vanes increase the dwell time of gas in the canister, thereby increasing the amount of carbon dioxide removed from the gas. Such construction can be implemented in rebreathers having radial, axial or cross-flow designs.

This application claims the benefit of U.S. Provisional Application No. 60/658,606, filed Mar. 4, 2005, which is incorporated herein by reference in its entirety.

### BACKGROUND

1. Field of the Invention

The present invention relates generally to a fluid filtering device and more particularly to a re-breathing apparatus that absorbs undesired carbon dioxide from exhaled gas.

2. Background Discussion

Conventional breathing systems, such as systems used for underwater diving situations, firefighting or outer space, typically provide a gas supply system to a user who is underwater, or in another oxygen-depleted environment. These systems are typically portable and are adapted to provide sustained usable air for breathing for an estimated period of time.

Examples include portable, Aqua-lung or SCUBA (Self Contained Underwater Breathing Apparatus) gear which is used by free divers and in similar form, by fire fighters in many hazardous situations. Typically, SCUBA-type apparatus employ a relatively large compressed air tank, a mouthpiece or face mask connected to the tank through a flow regulator. Users inhale from the tank and exhale into the ambient atmosphere.

Another type of apparatus, a re-breathing apparatus, has been developed to recycle the exhaled gas to remove carbon dioxide therefrom with a “scrubber” and then recycle the unmetabolized oxygen. Oxygen or Oxygen-enriched gas is then injected into the “scrubbed” gas to maintain the partial pressure of oxygen in the gas at a desired level, and then the mixture is passed back to the user for re-breathing. Re-breathers can therefore extend the amount of time the breathing device can be used by lower the rate of consumption of the supply gas.

Early re-breather systems were relegated to use by professionals in unsafe environmental conditions, such as diving or firefighting due to the complexity and costs of the systems, in addition to the extensive training required for the use of these systems. Although the systems are relatively simple in construction, since pure oxygen is utilized, the early systems were undesirable due to the problem of oxygen toxicity, i.e., if the partial pressure of oxygen (PPO₂) rises, or falls, this can be detrimental to the diver.

However, available breathing apparatus, as described above, have not been entirely satisfactory. This is particularly true in deep dive situations in which a diver would like to extend the duration of the dive as long as possible. Also, in underwater diving environments, it is necessary to not only provide a source of breathing gas, but also to consider that during deeper dives, pressure will increase and adversely affect the ability for a user to breathe using conventional systems.

It would be an advancement in the state of the art to increase the efficiency of re-breather apparatus and thereby increase the amount of time the re-breather can provide a usable supply of breathable air. This is particularly applicable to an operator in an oxygen starved environment, such as, e.g., a diver, increasing the amount of time that they can remain submerged.

### BRIEF SUMMARY OF THE INVENTION

The present invention is directed to an improved fluid filtering system that may be used for underwater diving, firefighting, space exploration and medical applications as well as any application that needs efficient and durable filtering of breathable gas or other fluid. As used herein, a fluid may be either a liquid or a gas or a combination of liquid and gas. The present invention increases the amount of time a user of a re-breather apparatus can remain in an oxygen-depleted environment. The increase in efficiency is due to intermediate members, or vanes, that are disposed between an inner canister, or ring, or mesh, or membrane and an outer canister, or ring, or mesh, or membrane of a scrubber canister, thereby increasing the ability of the scrubber canister to remove carbon dioxide from gas exhaled by a user.

Accordingly, one embodiment of the present invention relates to a breathing apparatus that includes a source of oxygen and a mouthpiece, which includes an inlet connected through a first one-way valve to receive inhaled gas, and an outlet having a second one-way valve to expel exhaled gas from a user. A scrubber canister is coupled to the mouthpiece and receives the output of the mouthpiece through the second one-way valve. The scrubber canister removes at least a portion of carbon dioxide from the exhaled gas from the user, and outputs carbon dioxide depleted gas. The scrubber canister has a first radial or axial member and a second radial or axial member and a plurality of intermediate members, each intermediate member disposed between an outer surface of the first radial or axial member and an inner surface of the second radial or axial member.

Another embodiment of the present invention relates to an apparatus for filtering fluid. The apparatus includes a first radial or axial member and a second radial or axial member, which is disposed around the first radial member. A plurality of intermediate members is disposed between an outer surface of the first radial or axial member and an inner surface of the second radial or axial member. An absorbent material is disposed between the outer surface of the first radial or axial member and the inner surface of the second radial or axial member.

Yet another embodiment of the present invention is directed to the apparatus for filtering fluid described above wherein each intermediate member is curved.

It will be appreciated by those skilled in the art that the foregoing brief description and the following detailed description are exemplary and explanatory of this invention, and are not intended to be restrictive thereof or limiting of the advantages which can be achieved by this invention. Thus, the accompanying drawings, referred to herein and constituting a part hereof, illustrate preferred embodiments of this invention, and, together with the detailed description, serve to explain the principles of this invention.

### BRIEF DESCRIPTION OF THE DRAWINGS

Additional aspects, features, and advantages of the invention, both as to its structure and operation, will be understood and will become more readily apparent when the invention is considered in the light of the following description of illustrative embodiments made in conjunction with the accompanying drawings, wherein:

FIG. 1 shows a diagram of a re-breathing apparatus.

FIG. 2 shows interior portions of a scrubber canister according to the present invention for a radial style canister.

FIG. 3 shows a chamber cover member for the scrubber canister according to the present invention.

FIG. 4 shows the exterior of the scrubber canister with an exterior cover member mounted thereon.

FIG. 5 shows a cutaway view of a portion of the canister wall.

FIG. 9 shows a plan view of two vanes according to the present invention for a radial canister.

FIG. 10 shows a cross-sectional view of a scrubber canister according to an illustrative embodiment of the present invention.

FIG. 11 shows an embodiment of the present invention that has vanes with multiple curved surfaces.

FIGS. 12 and 13 show perspective views of a scrubber canister according to an illustrative embodiment of the present invention.

FIG. 14 shows a chamber cover member 230 of FIG. 3 and canister 100 of FIG. 10.

FIG. 15 shows a partial assembly of the chamber cover member 230 of FIG. 3 and canister 100 of FIG. 14.

FIG. 16 shows exterior cover 235 for the partial assembly of FIG. 15.

FIG. 17 shows a perspective view of a complete assembly of the partial assemblies of FIGS. 14, 15 and 16, according to one embodiment of the present invention.

FIG. 18 shows an illustrative embodiment of an axial canister with a spiral vane according to an illustrative embodiment of the present invention.

FIG. 19 shows an illustrative embodiment of an axial canister with an undulating vane according to an illustrative embodiment of the present invention.

### DETAILED DESCRIPTION OF THE INVENTION

The present invention is directed to a new ‘vaned’ approach for scrubbing canisters, which has the ability to add duration without adding absorbent weight and hence path length, which in-turn is detrimental to breathing resistance.

While reference in the discussion which follows may be made, in any individual context or illustrative embodiment, to divers or firefighters and the need to supply filtered air for breathing in oxygen deprived or unclean air environments, the invention is equally applicable to any user in any situation where it is desired to supply or deliver a filtered fluid/gas, for example, astronauts in space, or pilots operating at high altitudes, as well as other underwater applications. Also, utility will be found, for example, in rescue, mining, military, medical or other operations conducted in hazardous/toxic environments or simply where delivery of a filtered fluid is needed or desirable. Also, as is understood in the art, while the term “fluid” is used herein, fluid is a term which is well understood to mean any material or substance which flows or moves whether in a semisolid, liquid, sludge, gas or any other form or state. A fluid, in its ordinary meaning, thus encompasses gas and liquid states or phases. An example of a gas is air. Where discussion herein refers to air or gas, it is for purposes of illustration only, and the principles discussed relative thereto will apply to other fluids and gases.

Typical scrubber canisters include a radial canister, which typically has a doughnut shape, cross section, where gas passes either from the inside layer to the outside or vice versa. An axial canister is a canister in which gas enters one end and passes through a block of absorbent material and exits out the other end. A Cross-flow Canister Gas enters in one end or the side and then changes direction and exits at the other end or side.

In the “doughnut design” of a radial re-breather canister, gas passes either from the outside diameter (outer ring) to the inside (outer ring) or visa versa, dependant on the design. A CO₂ absorbent material is housed between the inner and outer rings. The distance between the inner and outer rings provides the “dwell time” for which the CO₂ rich gas stays within the absorbent. By adding curved veins the dwell time can be extended with no detriment to breathing resistance.

The mechanical system of the illustrative embodiment of the scrubber canister according to the present invention comprises a series of curved vanes which when designed to a specific length and angle can increase the endurance of a carbon dioxide (CO₂) absorbent canister by a significant amount, in some cases in excess of 20% without compromising breathing resistance. The vane design is suitable for and adaptable to Radial, Axial and Cross-flow absorbent carrying systems. Other vane profiles may be used as appropriate.

The vanes, or intermediate members, are a series of curved plates of varying height and length dependant on the absorbent carrying case (canister) design or one continuous spiral of the same plate not unlike an Archimedean Screw in format. The use of the vanes, or continuous spiral of plating material serve to increase the path length, which is the length of the absorbent ‘bed’ of material.

While the specific dimensions of each style of vane will vary dependant on the external dimensions of the absorbent carrying outer case (and in the case of an Axial canister, may be configured in a spiral format), the concept of a curved gas path being generated that increases efficiency and maintains the work of breathing of the absorbent canister is maintained.

Tests indicate that by increasing the length of time the gas is maintained within the canister, the efficiency of the absorbent material can also be significantly increased. Furthermore the vane design does not affect breathing resistance adversely and also improves the flow characteristics of the canister.

Several preferred illustrative and alternative embodiments will now be described to assist in understanding the present invention.

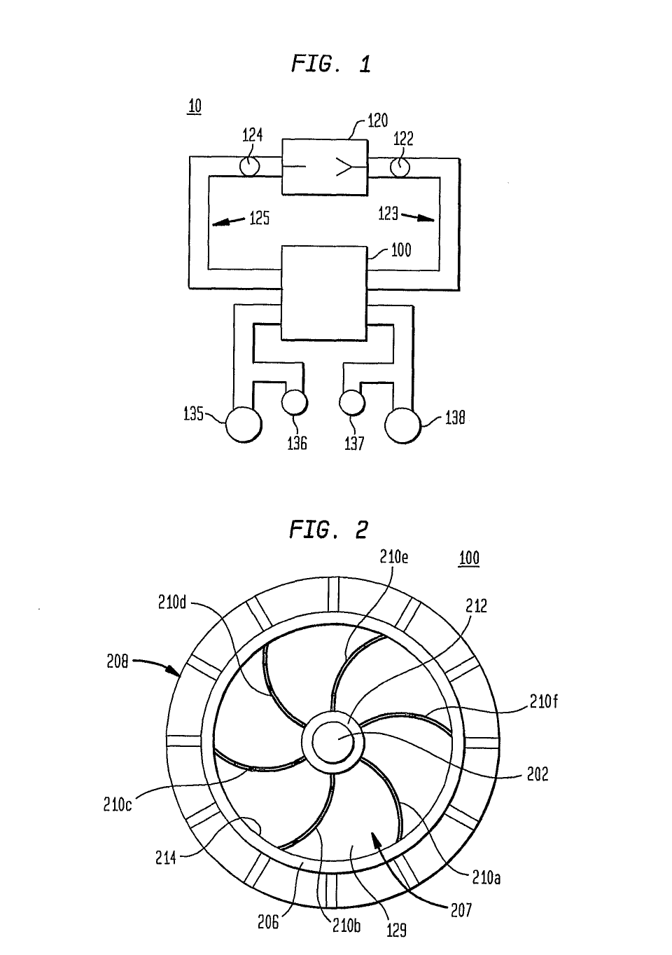

FIG. 1 shows a diagram of a re-breathing apparatus 10. Mouthpiece 120 is coupled to an upstream check valve 124 and a downstream check valve 122. The upstream check valve 124 is coupled to a hose 125 and downstream check valve 122 is coupled to a hose 123. The hoses 123 and 125 are coupled to a canister, or scrubber canister, 100. The re-breathing apparatus 10 circulates gas through scrubber canister 100, which as will be discussed in detail infra, includes an outer canister, or outer radial member, and an inner canister, or inner radial member.

An enriched gas supply 138 provides a source of such gas to the user via the canister 100. A diluent supply 135 is also coupled to the canister 100. Gauge 136 provides an indication of a level of diluent supply and gauge 137 provides an indication of a level of oxygen.

The oxygen supply 138 typically contains O₂ or O₂-enriched gas, which is contained at a relatively high pressure of approximately 300 bar, which is regulated down by a regulator to a pressure of approximately 400 psi.

The scrubber canister 100 is typically interfaced with two “counterlungs”, which include an inhalant counterlung and an exhalent counterlung. (Counterlungs not shown.) The counterlungs are operable to provide for a capacity approximating that of a full human lung such that, when the diver exhales, the full amount of exhalation gas is contained easily within the exhalent counterlung and the amount of gas contained in the inhalant counterlung can be drawn into the lungs when inhaling. The invention can also be applied to other re-breather embodiments that have only one counterlung, positioned on either side of the canister.

FIG. 2 shows interior portions of the scrubber canister 100 according to one embodiment of the present invention. The scrubber canister 100 includes an inner canister, or inner radial member 202, an outer canister, or outer radial member, 206, which surrounds the inner canister 202. The outer canister 206 is mounted to a base member 208.

The outer canister 206 surrounds the inner canister 202 to form an area 207 between the outer surface 212 of the inner canister 202 and an inner surface 214 of the outer canister 206. One or more intermediate members 210(a) . . . (f) are mounted on the outer surface 212 of the outer canister 202, such that they extend to the inner surface 214 of outer canister 206. Typically the area 207 contains a scrubber material 129, such as a carbon dioxide absorbent material, for example Sofnalime 797.

Intermediate members 210(a) . . . (f) are in the illustrative embodiment curved vanes that are disposed in the area 207. Although six vanes are shown, the quantity may vary depending on the dimensions of canister 100, or specifications of an application. The number of vanes may be any suitable number. Each member, generally 210, is secured to the inner radial member 202 and the outer radial member 206. The shape of each member 210 may be straight or curved. Curved radii in the illustrative embodiment are between 50 millimeters and 200 millimeters but any suitable curvature may be used. While the profile of the vane member in the illustrative embodiment is described as being curved in the horizontal dimension X (see FIG. 8) and substantially flat in the vertical dimension Y (See FIG. 8), the vertical dimension can be curved as well, in addition to or in lieu of curvature of the horizontal dimension.

The intermediate members 210 can be fabricated from metal, such as stainless steel or aluminum; a polymer material, such as plastic, PVC; or other material that exhibits the desired properties of hardness, flexibility, corrosion resistance and durability. In another alternative embodiment, inner canister 202 may be formed as a solid rod, or bar to which the intermediate members may be attached.

In the illustrative inside out re-breather, gas is passed through an inlet port (not shown) from the exhalation counterlung down to the bottom of the outer canister 206 and then passes around the lower surface thereof, which is generally dish-shaped and then is directed up through the bottom of the inner canister 202 and into the carbon dioxide absorbent material, or scrubbing material, 129. The gas passes through the scrubbing material 129 up to the outlet port, by which time a portion of the CO₂ is removed and the unmetabolized oxygen that was output from the exhalation counterlung is then passed back to the inhalation counterlung. The intermediate members 210 substantially increase the dwell-time, which is the amount of time the gas is circulated through the scrubber canister 100, thereby substantially increasing the amount of carbon dioxide removed from the gas.

The intermediate members 210 may extend the entire linear dimension of the canister 100 or any portion thereof to increase the dwell-time. The increased dwell-time increases the amount of carbon dioxide that is removed, or “scrubbed” from the gas in the canister. The increased removal of carbon dioxide increases the amount of time a user can remain in an oxygen-depleted environment.

The outer canister 206 can be manufactured of polyethylene, or material with similar properties, that increases insulation and ultraviolet light radiation resistance.

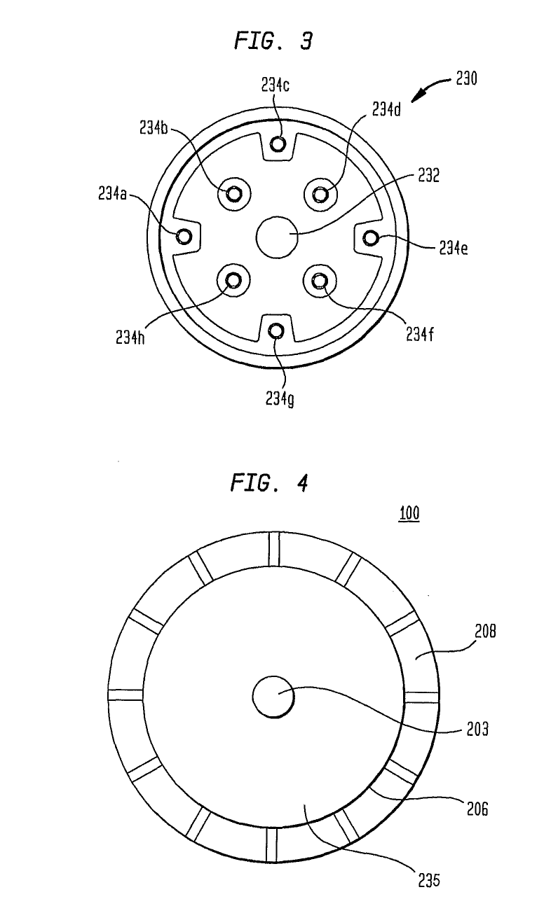

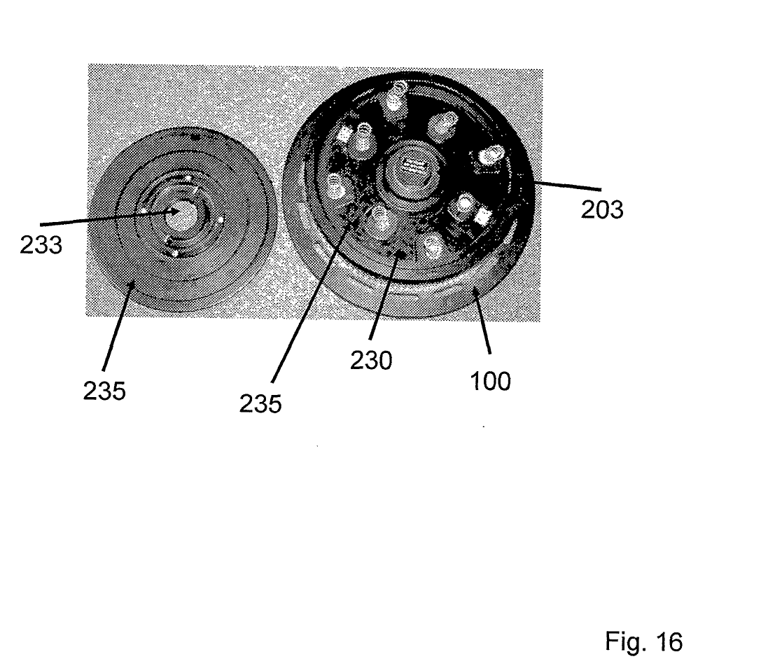

FIG. 3 shows a chamber cover member 230 for the canister according to the present invention. The cover member 230 has an opening, aperture, or orifice 232 that provides a substantially interference fit with an upper portion of the inner canister (shown as element 202 herein). The chamber cover member 230 has springs 234(a) . . . (h), which enable the cover member to securely engage with the canister (shown as element 100 herein) as will be discussed with respect to FIG. 16 infra. While eight springs are shown, the number of springs may vary based on the design specifications of the canister.

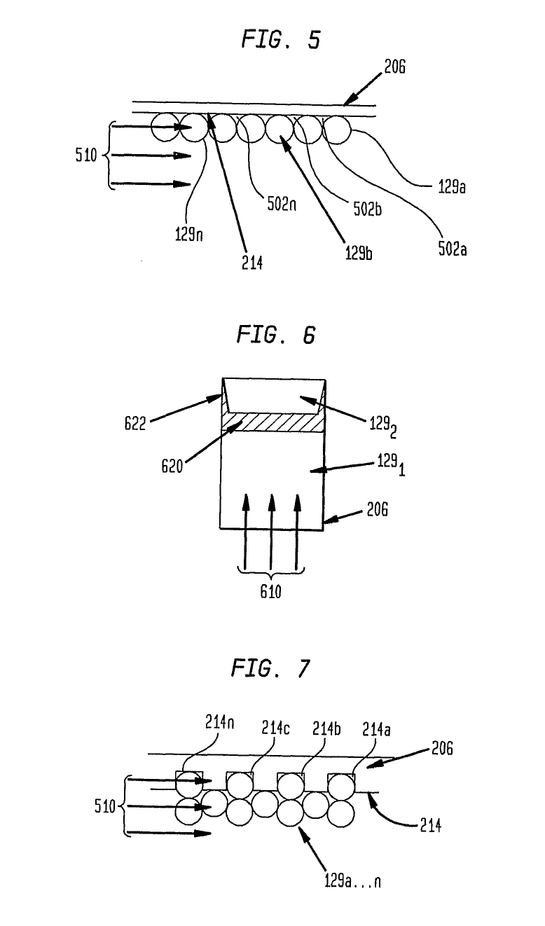

FIG. 4 shows the exterior of the canister 100 with the chamber cover member 230 (not visible) and exterior cover 235 (See FIG. 16) mounted thereon. The upper portion 203 of inner canister 202 is shown as extending through the opening of the cover member 235. The canister base member 208 is also shown.

FIGS. 5 and 6 show flow characteristics within a canister and FIG. 7 shows an additional embodiment of the scrubber canister design to increase the duration of the chemical absorbent. This embodiment includes the addition of extra features within the canister walls to reduce the acceleration affect of the gas as it makes contact with the sidewalls. This acceleration is due to the small gas spaces made when the absorbent granules contact the sidewall.

FIG. 5 shows a portion of the canister wall. As shown in FIG. 5, outer canister 206 has inner surface 214. Gas flow 510 interacts with absorbent granules 129(a), (b) . . . (n) (where n is the number of absorbent granules). Spaces 502(a), (b) . . . (n) (where n is the number of gas spaces) are within the absorbent material granules, generally 129.

FIG. 6 shows gas flow through a scrubber canister. The acceleration of the gas flow shown above is increased by the addition of carbon dioxide rich gas 610. Canister wall 206 contains used absorbent material 129₁. A wave front of the used absorbent material 129₁ is shown as element 620, which separates fresh absorbent material 1292. A premature breakthrough point is shown as 622. This increase in gas acceleration in radial, axial, cross flow or combination canisters generates a wave front through the absorbent which reduces the absorbent life due to premature CO₂ breakthrough near the side walls.

FIG. 7 shows a solution to the negative effects illustrated in FIGS. 5 and 6. An interior wall section 214 of the outer canister wall 206. The interior wall section 214 has a series ridges, or detents 214(a), (b), (c) . . . (n) that increase the distance the gas 510 must travel through the scrubber canister. Thus, the gas stream 510 has greater exposure to absorbent particles, or granules 129(a) . . . (n). The enhancement can be added to any type of canister design be it radial, cross-flow or axial or any combination of the three.

FIG. 8 shows a side view of a vane 210 according to the present invention. The dimensions and shape (along both the x and y axis shown) of the vane 210 will vary according to the canister dimensions and particular design.

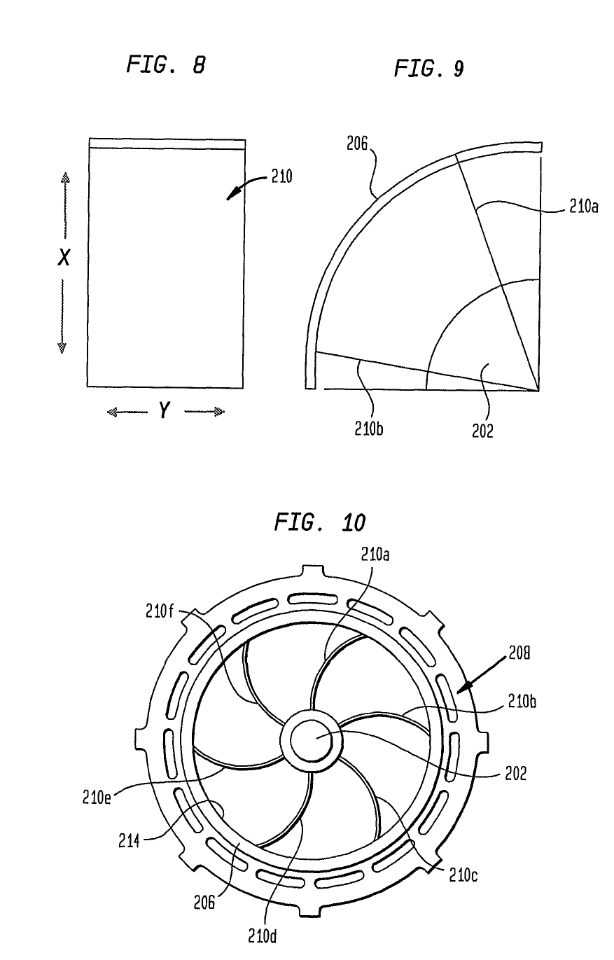

FIG. 9 shows a plan view of two vanes 210(a) and 210(b) according to the present invention. The vanes 210(a) and 210(b) are disposed between the inner canister 202 and outer canister 206. While shown as being substantially flat in FIG. 9 for ease of illustration, curved profiles are employed as shown in the illustrative embodiments discussed herein (e.g., FIGS. 2, 10 and 11). However, as mentioned, vanes of varying profiles, straight, curved or otherwise, are to be considered to be within the scope of the present invention.

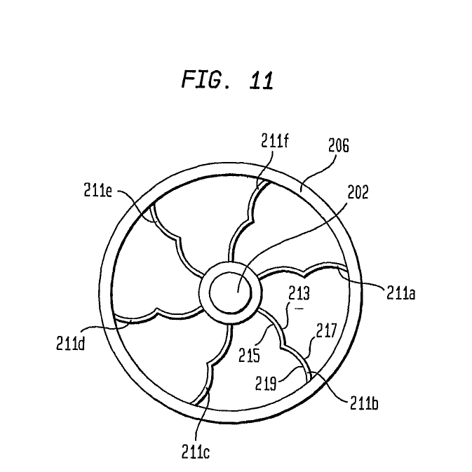

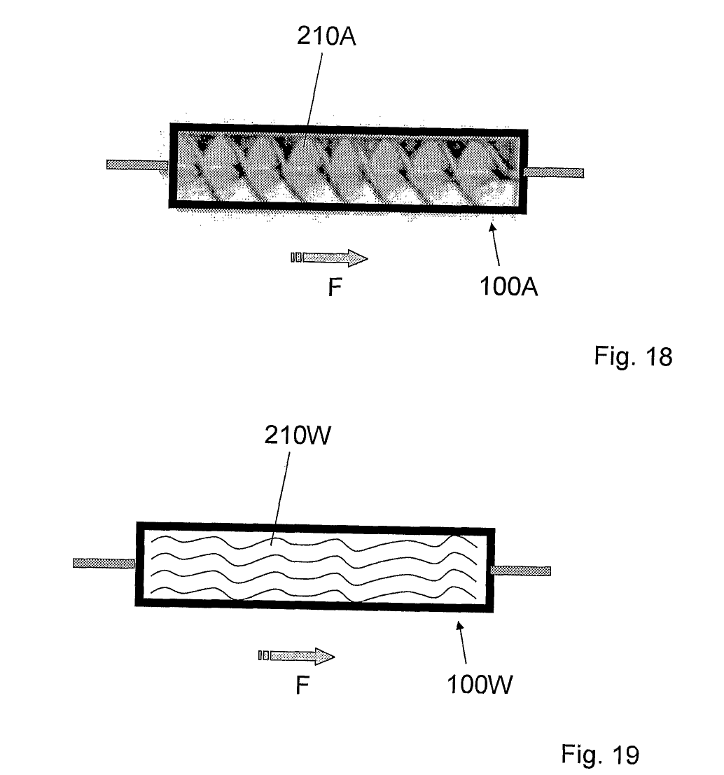

FIG. 10 shows a cross-sectional view of a scrubber canister according to the present invention. FIG. 10 shows the blade design according to the teachings of the present invention, as used with a radial style canister. Inner canister, or ring 202, outer canister, or ring 206, base 208, vanes 210 and surface 214, as described herein are shown. When the same principals of the invention are used on axial or cross-flow canisters, then the vanes would take the form of a spiral very similar in construction to an “Archimedean Screw” as will be described with respect to FIG. 18 infra.

FIG. 11 shows an embodiment of the present invention that has vanes with multiple curved surfaces. Each vane 211(a) . . . (f) shown has 2 curved surfaces. These surface areas are shown as 213, 215 and 217, 219. The degree of curvature of each portion of the vane can be from approximately one (1) degree to ninety (90) degrees. Other curved or undulating designs, including more than 2 curved portions, are within the scope of the present invention.

The device described herein can be formed as a series of machined parts in Delrin plastic, which either form multiple, for example four, six, eight, or ten individual vanes as shown herein, or one continuous spiral vane (See FIG. 18) which can be seen to be a direct extrapolation of the 2 dimensional vane but applied in a spiral screw format.

Alternatively, in the two dimensional format the vanes may be simply placed within the absorbent material pathway and anchored at each end. They may be equally spaced radially around the diameter of the canister. Canisters of varying diameter will have shorter or longer vanes installed the length being dependant on the fact that the end of one vane does not overlap the start of the next. In the spiral version, a continuous vane is installed in the absorbent path, the pitch of the vane may be defined by the length of the absorbent material in the canister.

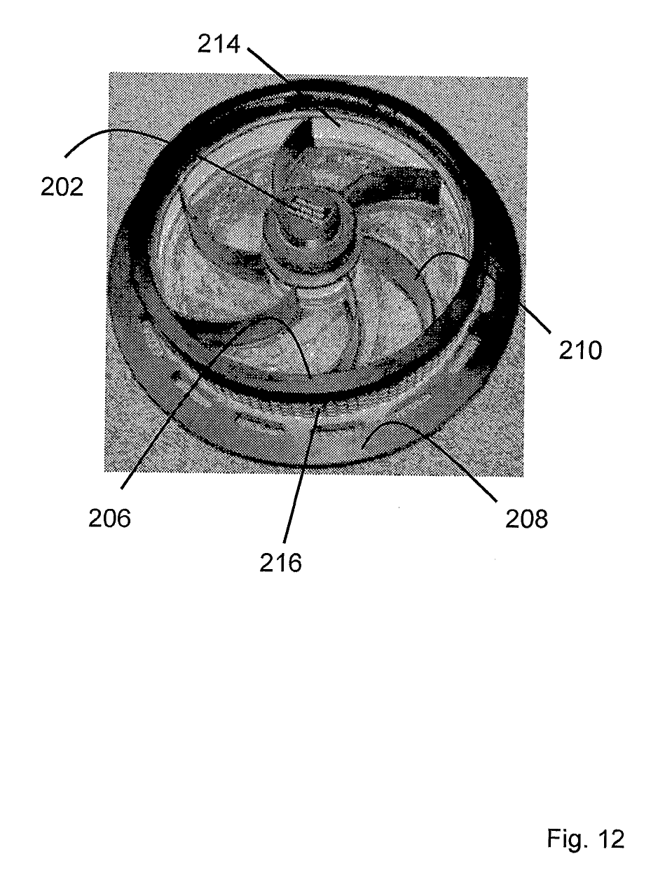

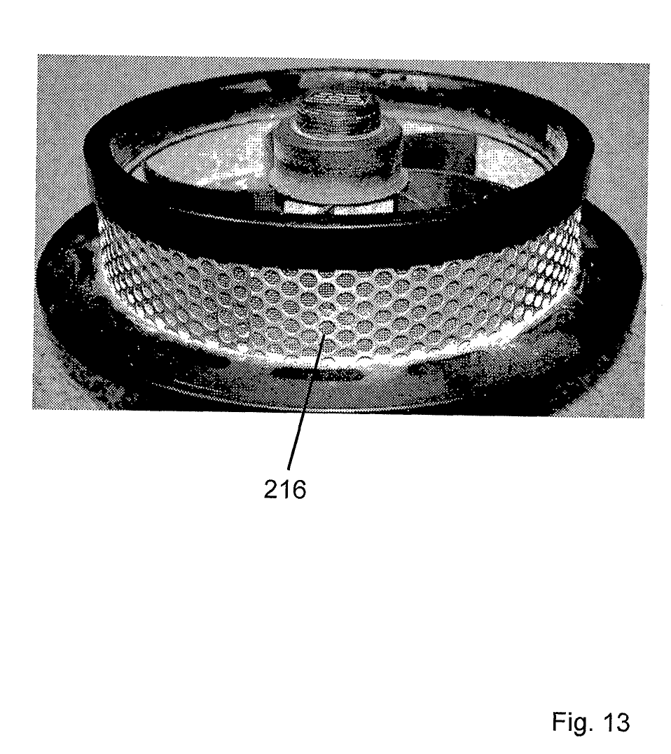

FIGS. 12 and 13 show perspective views of a scrubber canister according to the present invention, as discussed e.g., with respect to FIG. 10. FIG. 12 shows the blade design as used with a radial style canister. Inner canister, or ring 202, outer canister, or ring 206, base 208, vanes 210 and inner surface 214, as described hereinabove are shown. Also shown is exterior surface 216 of the outer canister 206. A perspective view clearly showing exterior surface 216 of the outer canister 206 is provided in FIG. 13. Outer surface 216 will be structural to form and support the outer canister 206 but should, as will be understood for the specific application, minimally restrict fluid/gas flow. Although it is not to be excluded that in some designs implementing the present invention for specific applications, some flow restriction may be desirable e.g., to create pressure differentials.

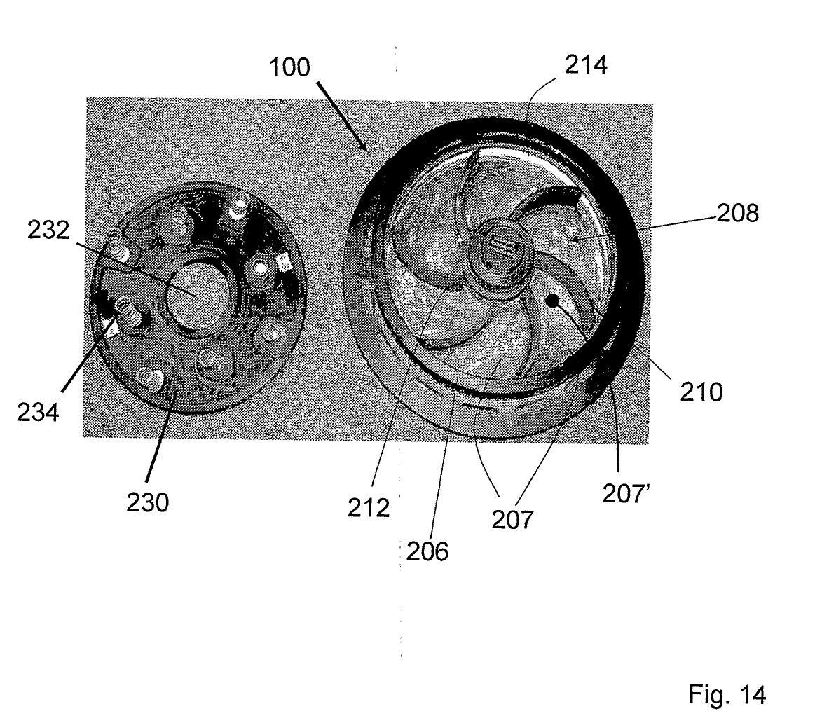

FIG. 14 shows chamber cover member 230 for the canister 100 as described in FIG. 3. The chamber cover member 230 is used to form chambers 207′ from areas 207. That is, as shown in FIG. 14, the areas 207 are defined in the volume between surface 212 of the inner canister 202 and an inner surface 214 of the outer canister 206, partitioned by vanes 210. Each area is bounded by base 208 and the under surface of cover 230. The chambers 207′ should be formed so as to maintain flow of the volume of gas in the chambers 207′ so that the gas progresses as desired to effect chemical scrubbing as discussed hereinabove. Chamber cover 230 should preferably sealably mate to canister 100. Springs 234, as will be discussed with respect to FIG. 16 infra, assist in secure attachment.

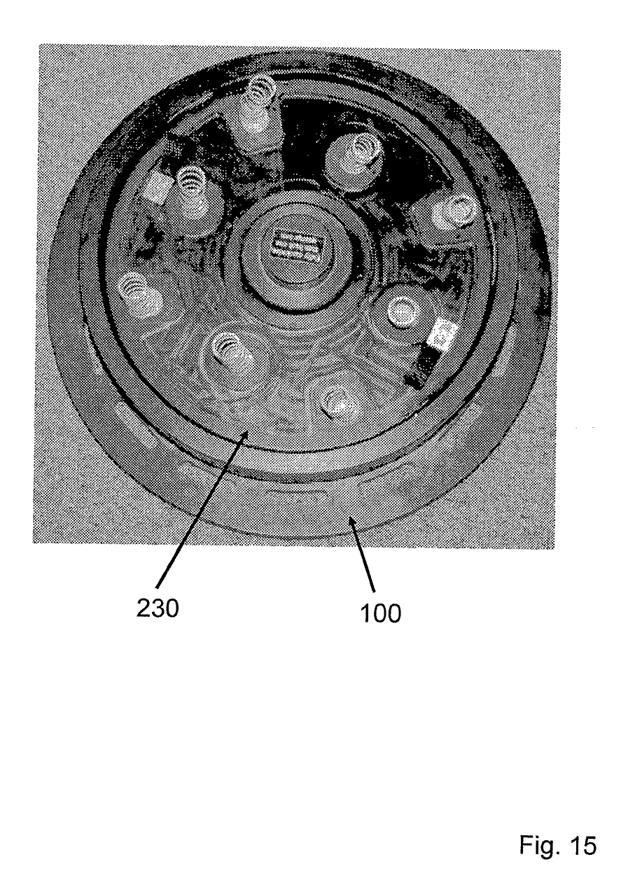

FIG. 15 shows chamber cover 230 mated to canister 100.

FIG. 16 shows exterior cover 235, with a center opening 233. Inner canister 202 has a reduced diameter portion 203, about which center opening 233 of external cover 235 aligns and is preferably friction fit. Other mechanical means for securing cover 235 to inner canister 202 can be implemented as desired—e.g., providing complementary threading on portion 203/canister 202 and the interior of opening 233, detent pin fastening, etc. The (underside of) exterior cover 235 applies force against springs 234 on chamber cover 230 to further securely engage chamber cover 230 as described above.

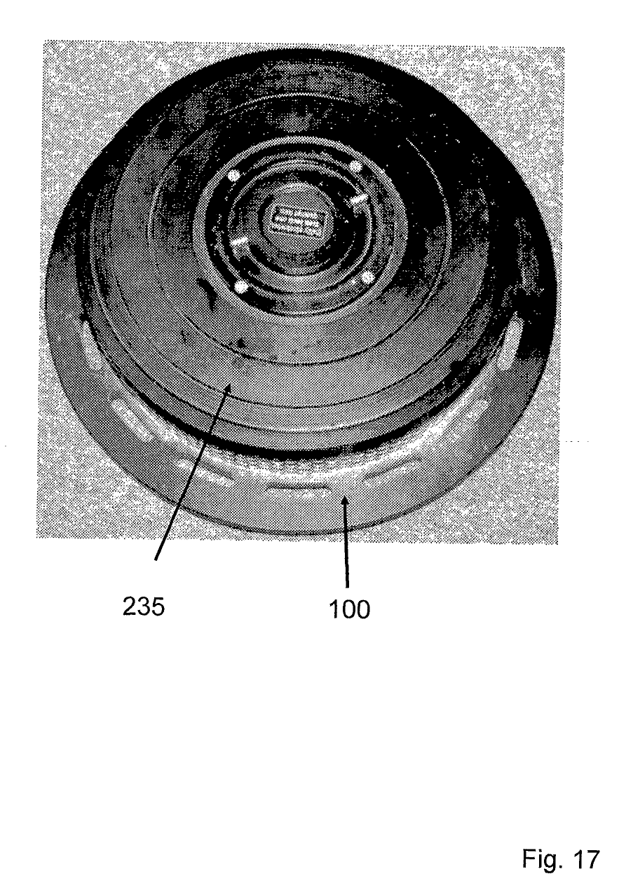

FIG. 17 shows exterior cover 235, chamber cover 230 (not visible) mated to canister 100. While chamber cover 230 and exterior 235 are shown as separate components, in alternative embodiments, such can be integrally formed. Moreover, other configurations to formed substantially sealed chambers in accordance with the teachings provided herein can also be devised and are considered to be within the scope of the present invention.

Other alternative embodiments of the present invention may be implemented based on alternative canister designs (e.g., axial, cross-flow) that include curved members (e.g., arcuate baffles) that increase the path length and/or dwell time though the scrubbing medium relative to such a canister design without such curved members. Such configurations bring about the effect of increased duration resulting in an increase in the probability of desirable molecular collision. That is, if there is, in a given volume at surface pressure, e.g., one molecule of CO₂, one CO₂ absorbent granule and one inert gas molecule, as the depth increases, there are more inert gas molecules, but the other molecules remain the same. Hence the probability of the CO₂ and absorbent granule colliding and the chemical scrubbing action taking place is reduced. The vanes of the present invention generate a level of turbulence in the volume which may increase the probability of collision between the CO₂ and absorbent granules to allow for chemical scrubbing.

For instance, an alternative embodiment such as is shown in FIG. 18 may be provided under the teachings of the present invention by using an axial flow canister 100A in which exhaled air enters a port at one end or side of the canister and exits from a port at another (e.g., opposite) end or side, with flow in the direction of the arrow F, with the axial canister including an arcuate baffle structure that increases the path length between the entrance and exit port relative to a straight-line path between these ports. Such an arcuate baffle structure may be implemented as a helical, screw-like member 210A helically formed about a central axial member, and the canister housing may have a generally cylindrical inner surface that abuts or mates with the outer edge of the helical baffle (e.g., the inner surface of the canister may have a thread into which the helical baffle screws). In this way, the canister and helical baffle resemble an Archimedean screw, and air entering at the entrance port is guided by the baffle along a helical path to the exit port. As may be appreciated, such an Archimedean design may be implemented with more than one helical blade/baffle.

In yet another alternative implementation of an axial canister 100W such as is shown in FIG. 19, rather than using a helical baffle, the arcuate baffle structure may be implemented as one or more wave-like/undulating members 210W that extends between the entrance and exit ports.

As stated above, and illustrated in FIG. 11, each of the curved members (baffles) may have a single curve, or may be alternatively implemented with two curves (e.g., S-shaped) and/or more than two-curves, with the curvature and relative configuration of curved members being provided to further increase the path length and hence dwell time though the scrubbing material. The present invention may also utilize single curved vanes in the same canister as multi-curved vanes.

It is also an embodiment of the present invention that multiple vane members could be used in the same canister in a serial manner. Thus, a first vane or first set of vanes could be disposed at a first portion of the canister and a second vane or second set of vanes could be disposed at a second portion of the canister.

Although the preferred embodiment has been described in detail, it should be understood that various changes, substitutions and alterations can be made therein without departing from the spirit and scope of the invention as defined by the appended claims.

The present invention has been illustrated and described with respect to specific embodiments thereof, which embodiments are merely illustrative of the principles of the invention and are not intended to be exclusive or otherwise limiting embodiments.

In accordance with the foregoing description of illustrative embodiments of the present invention, and illustrative variations or modifications thereof, it may be appreciated that the present invention provides many features, advantages and attendant advantages, all or any one or more of which may not necessarily be incorporated in any particular embodiment of the present invention.

Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages. For example, while the detailed description is set forth in the context of embodiments using a re-breather having a radial design, the principles of the invention are equally applicable and adaptable to other devices such as axial and cross-flow re-breather devices as will be readily understood by those of skill in the art based on the teachings provided herein.

It is further noted that the terms and expressions have been used as terms of description and not terms of limitation. There is no intention to use the terms or expressions to exclude any equivalents of features shown and described or portions thereof. It is therefore intended that the present invention is not limited to the disclosed embodiments but should be defined in accordance with the claims that follow.

What is claimed is:

1. A breathing apparatus comprising:
a source containing oxygen;
a mouthpiece that includes an inlet connected through a first one-way valve to receive inhaled gas, and an outlet having a second one-way valve to expel exhaled gas from a user; and
a scrubber canister, coupled to the mouthpiece, for receiving the output of the mouthpiece through the second one-way valve, and removing at least a portion of carbon dioxide from the exhaled gas from the user, and outputting carbon dioxide depleted gas,
wherein the scrubber canister has a first radial member and a second radial member and a plurality of intermediate members, each intermediate member disposed between an outer surface of the first radial member and an inner surface of the second radial member.

2. The breathing apparatus as claimed in claim 1, wherein the plurality of intermediate members are fabricated from a polymer material.

3. The breathing apparatus as claimed in claim 1, wherein the plurality of intermediate members are curved.

4. The breathing apparatus as claimed in claim 3, wherein each of the curved members are curved with a radius of between approximately 50 to 200 millimeters.

5. The breathing apparatus as claimed in claim 1, wherein each of the intermediate members extend approximately the linear dimension of the canister.

6. The breathing apparatus as claimed in claim 1, further comprising a carbon dioxide absorbent material disposed between the first radial member and the second radial member.

7. An apparatus for filtering fluid comprising:
a first member;
a second member, disposed around the first member;
a plurality of intermediate members, each intermediate member disposed between an outer surface of the first member and an inner surface of the second member; and
an absorbent material disposed between the outer surface of the first member and the inner surface of the second member.

8. The apparatus as claimed in claim 7, wherein the plurality of intermediate members are fabricated from a polymer material.

9. The apparatus as claimed in claim 7, wherein the plurality of intermediate members are curved.

10. The apparatus as claimed in claim 9, wherein each of the intermediate members are curved with a radius of between approximately 50 and 200 millimeters.

11. The apparatus as claimed in claim 7, wherein each of the intermediate members extend approximately the linear dimension of the apparatus.

12. The apparatus as claimed in claim 7, wherein the absorbent material is a carbon dioxide absorbent material.

13. The apparatus as claimed in claim 7, further comprising ridge portions disposed on the inner surface of the outer member.

14. The apparatus as claimed in claim 7, wherein each of the plurality of intermediate members has a plurality of curved surfaces.

15. The apparatus of claim 14, wherein the plurality of curved surfaces include at least one concave surface and one convex surface.

16. An apparatus for filtering fluid comprising:
a first member;
a second member, disposed around the first member; and
an intermediate helical member, disposed between an outer surface of the first member and an inner surface of the second member,
wherein the intermediate helical member is disposed along a portion of the linear dimension of the second member.
